(19) United States
(12) Patent Application Publication
(10) Pub. No.: US 2004/0245752 A1
(43) Pub. Date: Dec. 9, 2004

(54) Supplemental restraint controller

(76) Inventors: Andre Payant, Madison Heights, MI (US); Scott Morell, White Lake, MI (US)

Correspondence Address: SIEMENS CORPORATION, INTELLECTUAL PROPERTY LAW DEPARTMENT, 170 WOOD AVENUE SOUTH, ISELIN, NJ, 08830, US

(21) Appl. No.: 10/839,788

(22) Filed: May 5, 2004

Related U.S. Application Data
(60) Provisional application No. 60/468,044, filed on May 5, 2003.

(51) Int. Cl. B60R 21/32

(52) U.S. Cl. 280/735

(57) ABSTRACT

A supplemental restraint controller includes a main control portion and a safing control portion. In one example, the control portions communicate using one of pulse width modulation, frequency modulation or discrete digital signals. In one example, general input/output ports of an integrated circuit chip are used for establishing the communication between the main control portion and the safing control portion. In a disclosed example, the safing control portion includes an internal oscillator that provides cost savings and space savings.

### CROSS REFERENCE TO RELATED APPLICATIONS

This application claims priority to U.S. Provisional Application No. 60/468,044, which was filed on May 5, 2003.

### BACKGROUND OF THE INVENTION

Various vehicle supplemental restraint arrangements are known. Airbags are commonly utilized as supplemental restraint devices. Typical arrangements include a variety of sensors supported on the vehicle for detecting unsafe driving conditions or crash situations, for example. The sensor signals are processed by a controller that determines whether the sensor outputs indicate that a supplemental restraint should be deployed.

A variety of control strategies are known for determining when to deploy an airbag, for example. Typical controllers include a main control portion that interprets the sensor signals and determines whether to deploy the supplemental restraint. Some arrangements include an electromechanical switch that provides a backup function to the main controller. The electromechanical switch is arranged to allow for supplemental restraint deployment under selected conditions. In the event that the main controller, for example, malfunctions in a way that would result in deploying the supplemental restraint while the electromagnetic switch conditions are not satisfied, the electromagnetic switch prevents undesirable deployment of the supplemental restraint.

While such electromagnetic switches have proven useful, they are not without limitations and drawbacks. One limitation is that the electromagnetic switches are not testable in a manner that they can be automatically tested and reset for periodic verification of their operation condition. Additionally, the electromagnetic switches have no communication capability for communicating with the main control portion.

One improvement includes using a secondary microprocessor that communicates with the main control portion over a serial communication bus. The secondary microprocessor provides additional testing and verification capabilities but introduces additional complexity and cost into the overall controller arrangement. In automotive applications, cost savings are a primary consideration.

There is a need for an improved arrangement that provides better functionality than the known electromechanical switches and avoids the additional cost and complexity associated with secondary microprocessors that rely upon serial communications over a bus line, for example. This invention addresses those needs.

### SUMMARY OF THE INVENTION

In general terms, this invention is a supplemental restraint controller that includes a safing control portion that is efficient, cost effective and readily fit within tight packaging constraints.

One example disclosed embodiment of a controller includes a main control portion that interprets sensor signals for determining whether to deploy a supplemental restraint. A safing control portion communicates with the main control portion using at least one of pulse width modulation, frequency modulation or discrete digital signals. Such communication techniques allow for employing a safing control portion that is very cost effective and provides functionalities such as testing of the safing control portion and verification of the operation status of the main control portion.

Another disclosed example controller includes a main control portion that interprets sensor signals for determining whether to deploy the supplemental restraint. A safing control portion that controls whether the supplemental restraint can be deployed includes an oscillator that is internal to the safing control portion. Having an internal oscillator makes the safing control portion more cost-effective than arrangements that rely upon an external oscillator.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 schematically illustrates a vehicle including a supplemental restraint controller designed according to an embodiment of this invention.

FIG. 2 schematically illustrates one example controller arrangement.

### DETAILED DESCRIPTION

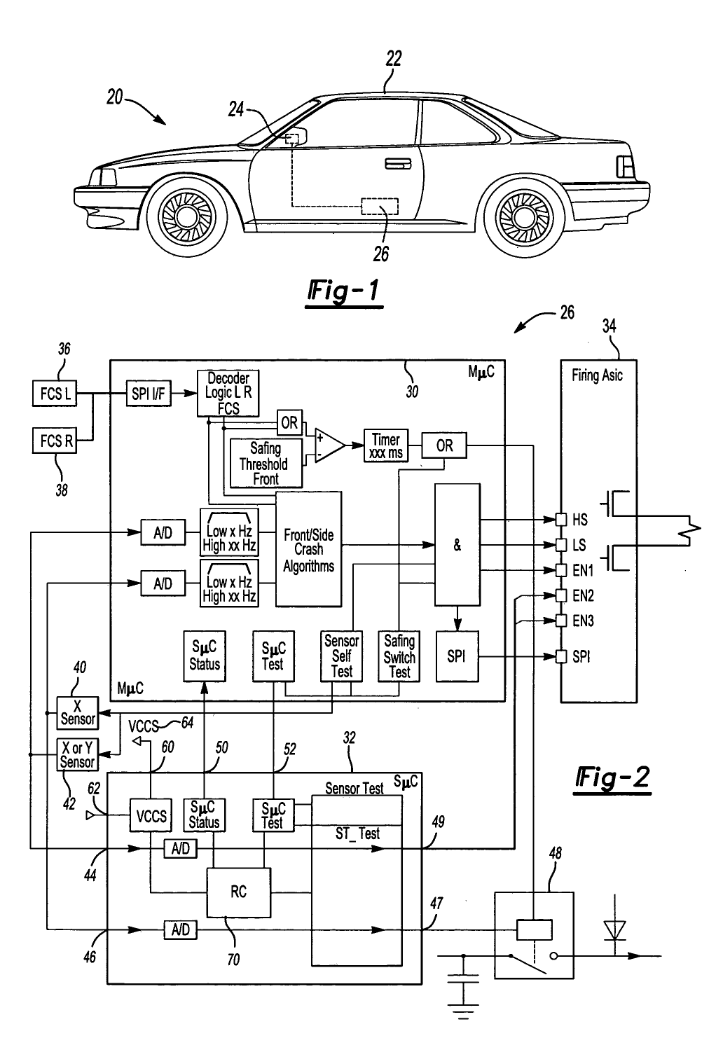

FIG. 1 shows a supplemental restraint system 20 supported on a vehicle 22. A supplemental restraint device 24, such as an airbag, is supported on the vehicle 22 in a known manner. A controller 26 controls operation of the supplemental restraint 24 in a known manner. For example, the controller 26 interprets signals from a plurality of crash sensors supported on the vehicle and makes a determination whether to deploy the supplemental restraint (i.e., inflate the airbag).

FIG. 2 schematically shows an example embodiment of the controller 26. In this example, a main control portion 30 is primarily responsible for interpreting the sensor signals that are used to decide whether to deploy the supplemental restraint 24. A safing control portion 32 operates as a safeguard or back up to the main control portion 30 to ensure desired operation of the system 20. The illustrated example includes a firing Asic 34 that operates in a known manner to cause inflation of an airbag, for example.

The illustrated example includes front crash sensors 36 and 38 that provide signals to the main control portion 30. Central sensors 40 and 42, which can be supported on the same substrate as the main control portion 30 and the safing control portion 32 as part of the controller 26 in a central location of the vehicle, also provide driving condition indications.

In the illustrated example, the safing control portion 32 is embodied on an eight pin integrated circuit chip. Two of the input pins 44 and 46 are dedicated to receiving signals from the sensors 40 and 42. An output 47 pin provides signals for controlling a conventional firing transistor 48, for example. An output pin 49 corresponding to the input pin 44 provides an output directly to the firing Asic 34 for known control, for example.

Two general input/output ports 50 and 52 are used for communication with the main control portion 30. A significant advantage to the illustrated embodiment is that effective communication between the main control portion 30 and the safing control portion 32 can be accomplished in a cost-effective manner to provide a variety of functions within a small packaging envelope. In one example, two general input/output ports of the integrated circuit chip are used for communications between the safing control portion 32 and the main control portion 30. In one example, pulse width modulation is used to provide signals that can be readily processed through the general input/output ports 50 and 52 of the safing control portion 32. In another example, frequency modulation is used as the communication technique. In still another example, discrete digital signals that are received across a plurality of input/output ports are used in combination to provide digital communication information between the control portions.

The communication between the control portions in one example includes the ability to test the safing control portion 32. In this example, the main control portion 30 sends appropriate signals to the safing control portion 32 causing it to enter into a test mode. In one example, this includes lowering a sensor-detecting threshold of the safing control portion 32. The main control portion 30 in this example deflects at least one of the sensors 40 or 42 to cause a low-grade output from the sensor. The safing control portion 32 operates according to the test procedures and provides an output indicating whether the safing control portion 32 appropriately detected the sensor output. The main control portion 30 also receives the sensor output and then verifies whether the output from the safing control portion 32 is consistent with appropriate operation of that portion of the controller 26. Known techniques can be used for making such determinations. Such verification of the safing control portion 32 may occur on a selected periodic basis or upon each initialization of the controller 26, for example.

Another communication feature of the illustrated embodiment is that the safing control portion 32 receives a verification from the main control portion 30 that the operation status of the main control portion 30 is according to selected criteria. In one example, the main control portion 30 provides a status indication to the safing control portion 32 on a periodic basis. In the event that the status indication from the main control portion does not conform to an expected standard or is not present, the safing control portion 32 prevents the firing Asic 34 from responding to any signals from the main control portion 30 such that the supplemental restraint 24 will not be deployed as a result of a malfunctioning main control portion 30. The communication for this feature can be accomplished using the pulse width modulation, frequency modulation or discrete signal techniques described above. Again, general input/output ports of the integrated circuit chip of the example safing control portion 32 allow for effective and economical management of the controller 26.

In the illustrated example, the integrated circuit chip of the safing control portion 32 comprises an eight pin package. In addition to the inputs and outputs described above, two inputs 60 and 62 facilitate receiving battery power from a power source 64 and grounding the chip.

Another feature of the illustrated example is that the safing control portion 32 contains an internal oscillator 70. In one example, the oscillator is a RC circuit that operates in a known manner. Having an oscillator internal to the safing control portion presents a cost savings because it eliminates the previous requirement for an external oscillator. By reducing the number of components and connections required between components, the example embodiment provides additional cost savings and space savings for realizing a more efficient controller architecture.

Because the safing control portion 32 can be embodied as a microcontroller, an integrated circuit chip or an Asic, for example, it has the capability of providing the functions of testing, verification and other features that may be desirable depending on a particular situation. This represents a substantial improvement compared to electromechanical switches that were previously used as fail safes or backups to supplemental restraint controllers. Additionally, the example safing control portion 32 is fully programmable. The safing control portion 32 is responsive to the main control portion 30 using communication techniques that can readily be accomplished through a general input/output port on a chip, which reduces complexity and provides costs savings.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A supplemental restraint controller, comprising:
main control portion that interprets sensor signals for determining whether to deploy the supplemental restraint; and
a safing control portion that communicates with the main control portion using at least one of pulse width modulation, frequency modulation or discrete digital signals.

2. The controller of claim 1, wherein the main control portion communicates with the safing control portion to test the operation of the safing control portion.

3. The controller of claim 2, wherein the main control portion automatically adjusts a sensitivity of the safing control portion during the test of the safing control portion.

4. The controller of claim 2, including at least one sensor that provides an indication of a vehicle condition and wherein the main control portion at least partially deflects the sensor to provide a test output signal and the main controller determines whether the safing control portion detects the test output signal.

5. The controller of claim 1, wherein the main control portion communicates with the safing control portion to verify an operation condition of the main control portion.

6. The controller of claim 5, wherein the safing control portion only deploys the supplemental restraint under appropriate conditions when the communication from the main control portion indicates that the operation condition of the main control portion meets a selected criteria.

7. The controller of claim 1, wherein the safing control portion comprises an oscillator that is internal to the safing control portion.

8. The controller of claim 7, wherein the oscillator comprises an RC circuit.

9. The controller of claim 1, wherein the safing control portion comprises an integrated circuit chip and wherein the communication between the main control portion and the safing control portion is accomplished through at least two general input/output ports of the chip.

10. The controller of claim 1, wherein the communication comprises an indication of a status of the main control portion provided to the safing control portion and a testing of the safing control portion that is directed by the main control portion.

11. A supplemental restraint controller, comprising:
main control portion that interprets sensor signals for determining whether to deploy the supplemental restraint; and
a safing control portion that controls whether the supplemental restraint can be deployed, the safing control portion comprising an oscillator that is internal to the safing control portion.

12. The controller of claim 11, wherein the main control portion communicates with the main control portion using at least one of pulse width modulation, frequency modulation or discrete digital signals.

13. The controller of claim 12, wherein the main control portion communicates with the safing control portion to test the operation of the safing control portion.

14. The controller of claim 12, including at least one sensor that provides an indication of a vehicle condition and wherein the main control portion at least partially deflects the sensor to provide a test output signal and the main controller determines whether the safing control portion detects the test output signal.

15. The controller of claim 12, wherein the main control portion communicates with the safing control portion to verify an operation condition of the main control portion.

16. The controller of claim 15, wherein the safing control portion only deploys the supplemental restraint under appropriate conditions when the communication from the main control portion indicates that the operation condition of the main control portion meets a selected criteria.

17. The controller of claim 12, wherein the safing control portion comprises an integrated circuit chip and wherein the communication between the main control portion and the safing control portion is accomplished through at least two general input/output ports of the chip.

18. The controller of claim 12, wherein the communication comprises an indication of a status of the main control portion provided to the safing control portion and a testing of the safing control portion that is directed by the main control portion.

19. The controller of claim 11, wherein the oscillator comprises an RC circuit.

20. The controller of claim 11, wherein the safing control portion comprises an integrated circuit chip.
